(19) United States
(12) Patent Application Publication
(10) Pub. No.: US 2026/0153363 A1
(43) Pub. Date: Jun. 4, 2026

(54) MEASURING INSTRUMENT AND CONNECTION STRUCTURE

(71) Applicant: MITUTOYO CORPORATION, Kanagawa (JP)

(72) Inventor: Yuma ENDO, Tokyo (JP)

(73) Assignee: MITUTOYO CORPORATION, Kanagawa (JP)

(21) Appl. No.: 19/338,589

(22) Filed: Sep. 24, 2025

(30) Foreign Application Priority Data
Dec. 4, 2024 (JP) 2024-211694

(51) Int. Cl. G01D 5/20

(52) U.S. Cl. CPC G01D 5/20

(57) ABSTRACT

A measuring instrument includes a main body, a probe movable with relative to the main body, a movable member provided to move with the probe, a scale member fixed to a part of the movable member, and a detection member that electrically detects a displacement of the scale member, wherein the movable member and the scale member are fixed to each other by bonding with an adhesive in the bonding region, and in the bonding region, at least one of the movable member or the scale member includes a through hole into which the adhesive enters.

### CROSS-REFERENCE TO RELATED APPLICATIONS

The present application claims priority to Japanese Patent Application No. 2024-211694, filed on Dec. 4, 2024, contents of which are incorporated herein by reference in their entirety.

### BACKGROUND

The present disclosure relates to a measuring instrument and a connection structure. Conventionally, a digital gauge has been known that includes a probe configured to be movable relative to a main body (specifically, pivotable about an axis), and that electrically detects a displacement of the probe (for example, see U.S. Pat. No. 11,175,121).

In a structure in which a scale member is fixed to a member (bonded member), which pivots with the probe, and the displacement of the scale member is electrically detected as a relative amount of movement with respect to a detection member that is disposed to face the scale member with a predetermined gap therebetween, the following problem may arise.

First, in order to assemble such a structure, the bonded member is supported in a cantilever manner, the scale member is also supported in a cantilever manner, and these members are fixed to each other by applying an adhesive between them. However, in such a bonding process, slight dimensional or shape errors in the members can easily cause variations in the thickness of the adhesive. As a result, the gap and the orientation of the detection member, which is disposed to face the scale member, relative to the scale member fluctuate, thereby causing a problem in that detection accuracy of the measuring instrument decreases.

### SUMMARY

A measuring instrument according to one aspect of the present disclosure includes: a main body; a probe movable relative to the main body; a movable member provided to move with the probe; a scale member fixed to a part of the movable member; and a detection member that electrically detects a displacement of the scale member, wherein the movable member and the scale member are fixed to each other by bonding with an adhesive in a bonding region where the movable member and the scale member overlap each other, wherein, in the bonding region, at least one of the movable member or the scale member includes a through hole or a recessed portion, into which the adhesive enters.

### BRIEF DESCRIPTION OF THE DRAWINGS

FIG. 1A is a perspective view of a measuring instrument according to one embodiment of the present disclosure.

FIG. 1B is a perspective view of a measuring instrument according to one embodiment of the present disclosure.

FIG. 2 is a planar view of the measuring instrument.

FIG. 3A shows only some parts of the measuring instrument.

FIG. 3B shows only some parts of the measuring instrument.

FIG. 4A is a diagram for explaining a possible problem that may occur in adhesive fixation.

FIG. 4B is a diagram for explaining a possible problem that may occur in adhesive fixation.

FIG. 5A is a view showing a bonding portion between a movable member and a scale member.

FIG. 5B is a view showing a bonding portion between a movable member and a scale member.

FIG. 6 is a view showing part of the assembly procedure of the measuring instrument and showing a jig used at the time of assembly.

FIG. 7 is a flowchart showing the assembly procedure.

FIG. 8A is a view schematically showing steps of applying an adhesive and curing the adhesive.

FIG. 8B is a view schematically showing steps of applying an adhesive and curing the adhesive.

FIG. 8C is a view schematically showing steps of applying an adhesive and curing the adhesive.

FIG. 9A is a diagram for explaining a specific configuration example of a through hole and its peripheral structure.

FIG. 9B is a diagram for explaining a specific configuration example of a through hole and its peripheral structure.

FIG. 10A is a view showing an example of the through hole.

FIG. 10B is a view showing an example of the through hole.

FIG. 10C is a view showing an example of the through hole.

FIG. 10D is a view showing an example of the through hole.

FIG. 10E is a view showing an example of the through hole.

FIG. 11 is a cross-sectional view illustrating an example in which a recessed portion is formed in the movable member.

### DETAILED DESCRIPTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

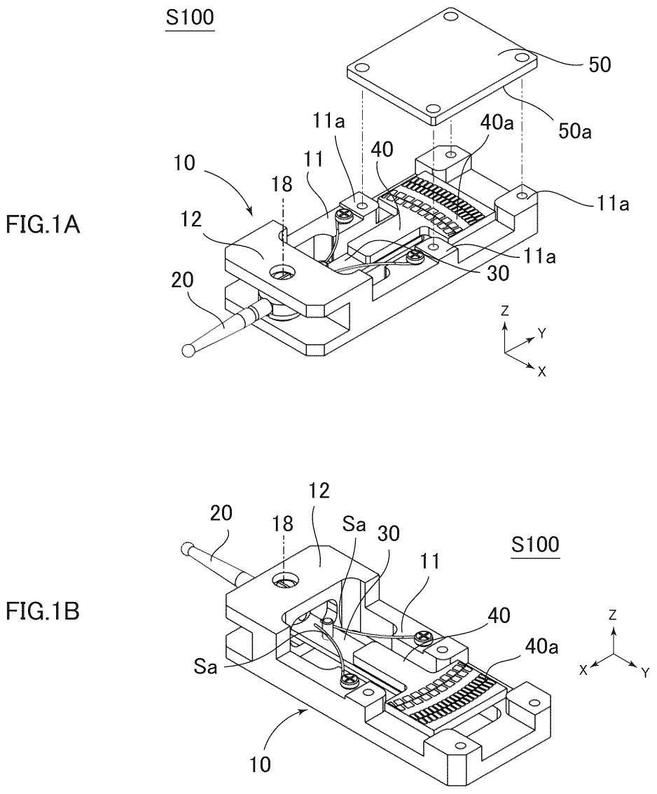

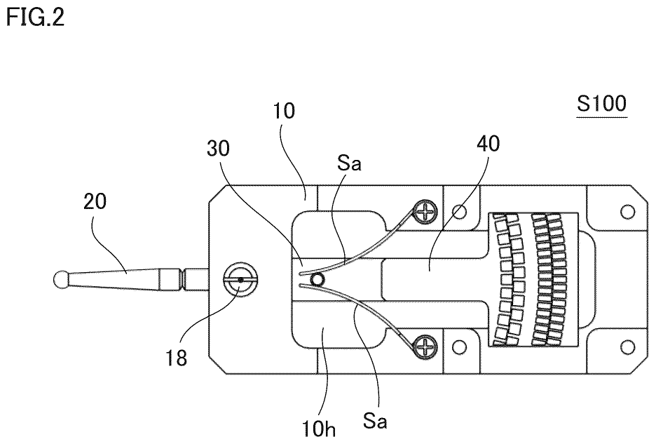

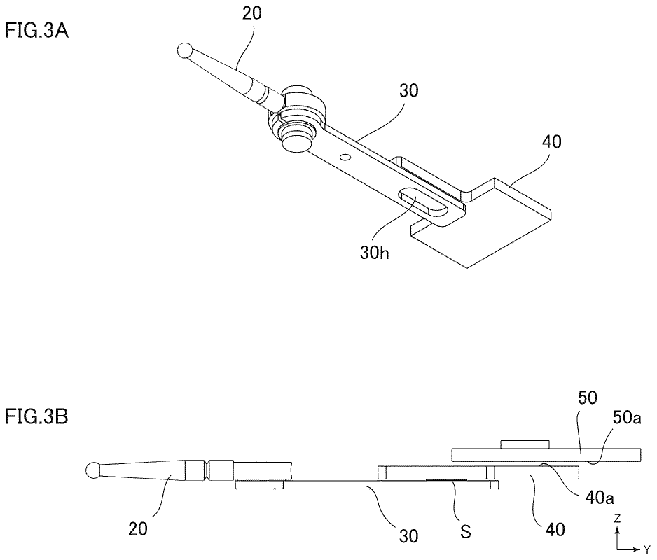

Hereinafter, embodiments of the present disclosure will be described. FIG. 1 is a perspective view of a measuring instrument according to one embodiment of the present disclosure. FIG. 2 is a planar view of the measuring instrument. FIG. 3 shows only some parts of the measuring instrument. It should be noted that, in each drawing of the present application, all components are not necessarily illustrated, and some components may be omitted. In the drawings, an X axis, a Y axis, and a Z axis are mutually orthogonal axes.

As illustrated in FIG. 1A a measuring instrument S100 includes a main body 10, a probe 20, a movable member 30, a scale member 40, and a detection member 50. In this example, the measuring instrument S100 is a lever-type gauge. The measuring instrument S100 is a digital measuring instrument that measures the displacement of the probe 20, which moves upon coming into contact with an object.

The main body 10 is a member constituting a housing of the measuring instrument S100. As one example, the main body 10 has a shape that extends along the Y-axis direction in the drawing. The main body 10 includes a scale mounting portion 11 and a probe support portion 12.

The scale mounting portion 11 is a portion that forms a space in which the scale member 40 is disposed. The probe support portion 12 is provided at an end portion of the main body 10. The probe support portion 12 holds the probe 20 in a pivotable state.

The probe 20 is an elongated rod-shaped member. A spherical portion that comes into contact with the object is formed at the distal end of the probe 20. The probe 20 is provided to be movable relative to the main body 10. Specifically, the probe 20 is provided so as to pivot about a rotation axis 18. In this example, the rotation axis 18 is an axis extending in the Z-axis direction.

The movable member 30 is an elongated plate-shaped member. In the present embodiment, the movable member 30 is fixed to a part of the probe 20 and extends in the Y-axis direction with the probe 20. Specifically, the movable member 30 is fixed to a part opposite to the distal end of the probe 20. The movable member 30 is provided so as to move with the probe 20. The movable member 30 is provided to be movable relative to the main body 10.

As shown in FIGS. 1B and 2, the movable member 30 is biased by a pair of springs Sa provided on the main body 10. The pair of springs Sa is a member for positioning the movable member 30 and the probe 20 at the center. The shape of the springs Sa shown in the drawings is merely an example, and the shape of the springs Sa is not limited to any specific shape.

The scale member 40 is fixed to a part of the movable member 30. The scale member 40 is also a plate-shaped member in the present embodiment, and a plurality of metal patterns are formed on a scale surface 40a, which is the surface of the scale member 40. In this example, the scale surface 40a is a surface extending in the X-Y plane. The scale member 40 is displaced so as to pivot around the rotation axis 18 in accordance with the displacement of the probe 20.

The detection member 50 is a sensor substrate that electrically detects the displacement of the scale member 40. The detection member 50 has a detection surface 50a. The detection member 50 is fixed to the main body 10. Specifically, the detection member 50 is fixed while being in contact with an attachment surface 11a of the main body 10. A fixing tool such as a screw is used for fixing. The detection member 50 is not fixed to the movable member 30, and thus the movable member 30 and the detection member 50 are configured to be relatively movable with respect to each other. When the scale member 40 is displaced, the relative position between the scale member 40 and the detection member 50 changes. The detection member 50 detects the displacement of the scale member 40 by using electromagnetic induction generated by this change.

The positional relationship between the movable member 30 and the scale member 40 will be described in detail with reference to FIGS. 3A and 3B. The probe 20, the movable member 30, and the scale member 40 shown in FIG. 3A are fixed to each other, and are an assembly that moves integrally as a whole. On the other hand, the detection member 50 shown in FIG. 3B is a member fixed to the main body 10 (see FIG. 1A). The detection member 50 thus does not move with the scale member 40. The detection member 50 and the scale member 40 are disposed facing each other with a predetermined gap in between.

### (Problems in Manufacturing the Measuring Instrument S100)

In such a configuration, in order to secure the detection accuracy of the measuring instrument S100, the scale member 40 needs to be positioned, with high positional accuracy, relative to the detection member 50. Specifically, it is important that the detection surface 50a of the detection member 50 and the scale surface 40a of the scale member 40 are provided parallel to each other, with a predetermined gap therebetween, with high accuracy, in order to maintain high detection accuracy of the measuring instrument S100.

In a measuring instrument of this type of detection system, the following method has conventionally been known as an assembly method of fixing a scale member to a detection member. That is, instead of fixing the scale member to the movable member using a screw or the like, the scale member and the movable member are fixed to each other with an adhesive while the scale member and the movable member are disposed at predetermined positions. The adhesive is applied to a portion where the scale member and the movable member face each other, and both members are fixed by curing the adhesive.

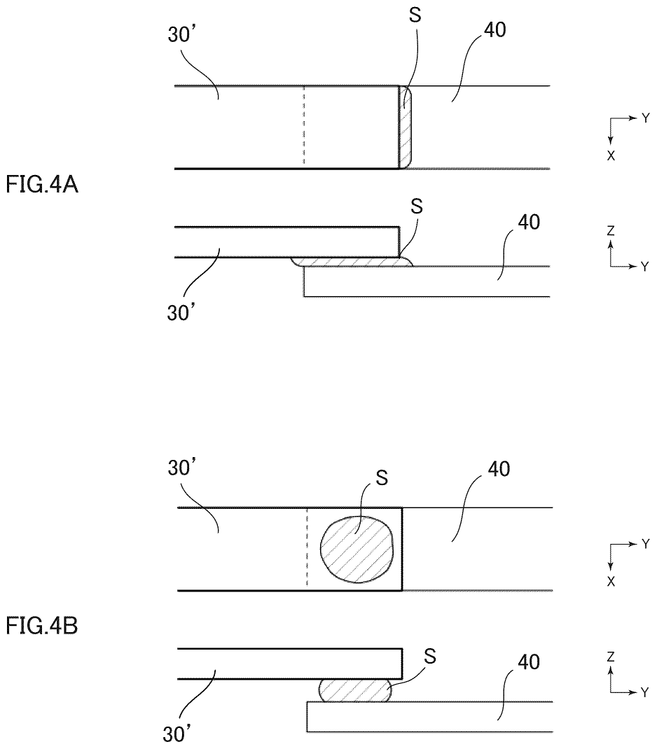

FIGS. 4A and 4B are each a diagram for explaining a possible problem that may occur due to adhesive fixation. A movable member 30′ and the scale member 40 are each supported, for example, in a cantilever manner by a member (not shown). FIG. 4A shows a state in which the gap between the movable member 30′ and the scale member 40 has become narrowed due to dimensional variations or shape error of components. In such a case, there is a possibility that an adhesive S will protrude from between the movable member 30′ and the scale member 40. Conversely, FIG. 4B shows a state in which the gap has become wide. In such a case, there is a possibility that the adhesive S will not fully spread over the entire bonding surface. In this state, there is a risk that the scale member 40 may become tilted or that the adhesive strength between the movable member 30′ and the scale member 40 may decrease.

(Structure into which Adhesive Enters)

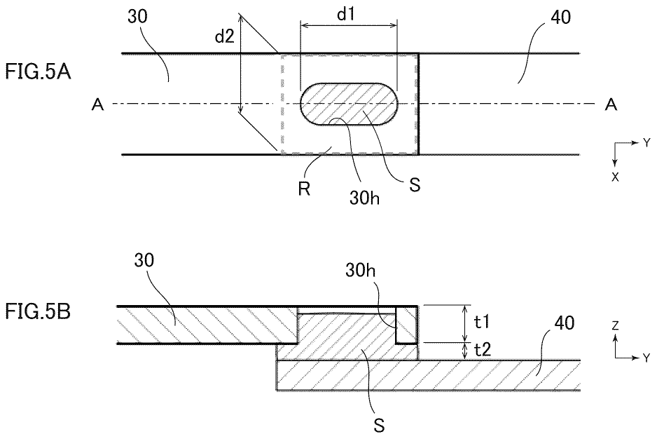

In order to solve the above-described problems, the following configurations are employed in the present embodiment. FIGS. 5A and 5B are each a view showing a bonding portion between a movable member and a scale member. FIG. 5A is a view of a connection portion between the movable member and the scale member as viewed from the movable member side. FIG. 5B is a cross-sectional view taken along a line A-A.

The movable member 30 and the scale member 40 are fixed to each other by being bonded with the adhesive S in a bonding region R where the movable member 30 and the scale member 40 overlap each other. The adhesive S is, for example, a photocurable adhesive that is cured by irradiation with light. Note that, in the present description, the bonding region R refers to a region (a region in which members overlap with each other) within a frame of a broken line of the square in FIG. 5A, and is a region including a portion in which a through hole 30h (see below) is formed.

The movable member 30 includes the through hole 30h. The through hole 30h penetrates the movable member 30 in the plate thickness direction. The outline shape of the through hole 30h may be any shape such as a circle, an oval, a rectangle, a polygon, an ellipse, and a combination thereof. In the present embodiment, the through hole 30h is, as an example, a slot (with semicircular end portions) extending along the extending direction of the movable member 30.

Since the movable member 30 includes the through hole 30h, when the movable member 30 and the scale member 40 are fixed, the adhesive S spreads between the movable member 30 and the scale member 40 in accordance with the gap between the movable member 30 and the scale member 40, and any remaining adhesive S enters (remains in) the inside of the through hole 30h. According to such a configuration, even if the gap between the movable member 30 and the scale member 40 fluctuates, the adhesive S is prevented from protruding or from failing to sufficiently spread between the members. As a result, the adhesion quality is maintained, and the scale member 40 can be accurately positioned relative to the detection member 50. That is, according to the measuring instrument S100 of the present embodiment, it is possible to prevent a decrease in the detection accuracy of the measuring instrument due to poor adhesion between the members.

### (Detailed Structure)

The maximum length d1 inside the through hole 30h is, for example, 20% or more of a length d2 of the bonding region R in the X direction (the length in the direction orthogonal to the extending direction of the scale member 40). The length d1 may be 30% or more of the length d2. If the through hole 30h is too small, there is a possibility that the adhesive S will not sufficiently enter the through hole 30h. However, by forming the through hole 30h in the above-described size, the adhesive S can more easily enter the through hole 30h. In the present embodiment, since the through hole 30h is a slot, the maximum length d1 corresponds to the length in the Y-axis direction, but in a case where the through hole 30h is circular, the “maximum length inside the through hole” refers to the inner diameter of the circle.

In terms of the relationship with the area of the bonding region R, the area of the through hole 30h may be 20% or more of the area of the bonding region R. The area of the through hole 30h may be 30% or more of the area of the bonding region R. Since the through hole 30h is formed in such a size, the size of the hole is sufficiently secured, and the adhesive S easily enters the through hole 30h.

With respect to the thickness of the movable member 30, it is preferable in one embodiment that a thickness t1 of the movable member 30 is greater than a thickness t2 of the gap into which the adhesive S enters. According to such a configuration, since the volume inside the through hole 30h is increased, even if the gap between the movable member 30 and the scale member 40 fluctuates, a state in which the space between the movable member 30 and the scale member 40 is filled with the adhesive S and the remaining adhesive S is retained inside the through hole 30h is more easily achieved. As a result, poor adhesion can be effectively prevented.

Regarding the relationship between the thickness of the movable member 30 and the thickness of the scale member 40, the movable member 30 in which the through hole 30h is formed may be formed to be greater than the scale member 40.

### (One Example of the Assembly Procedure)

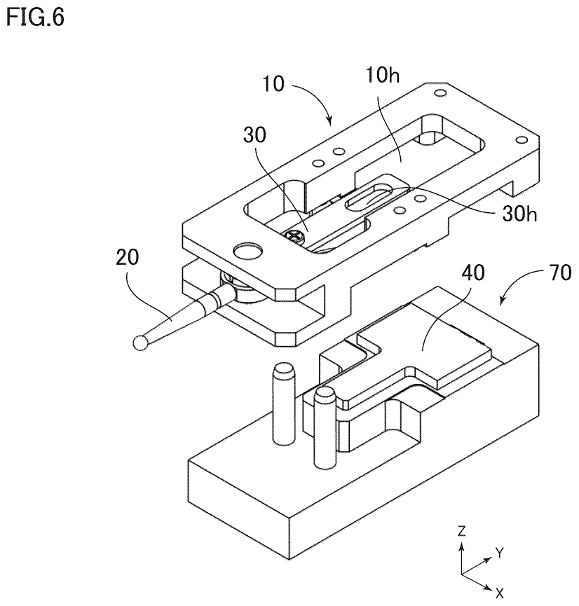

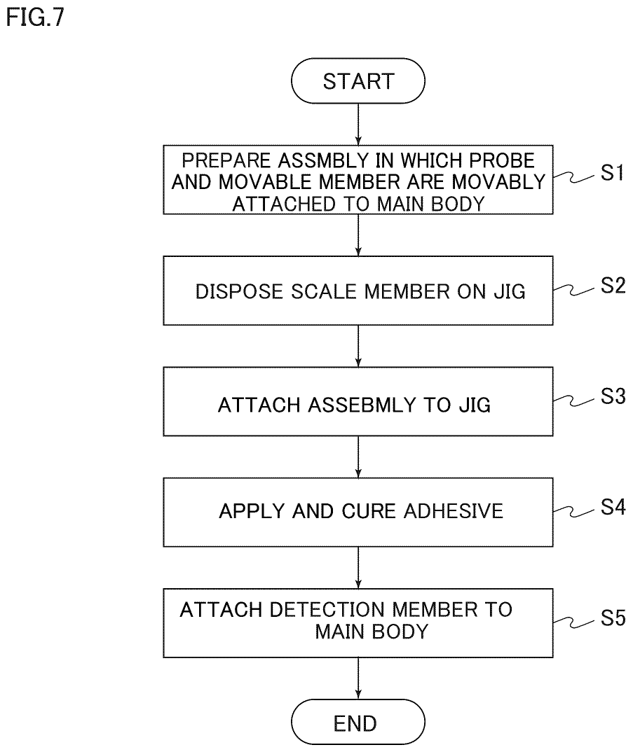

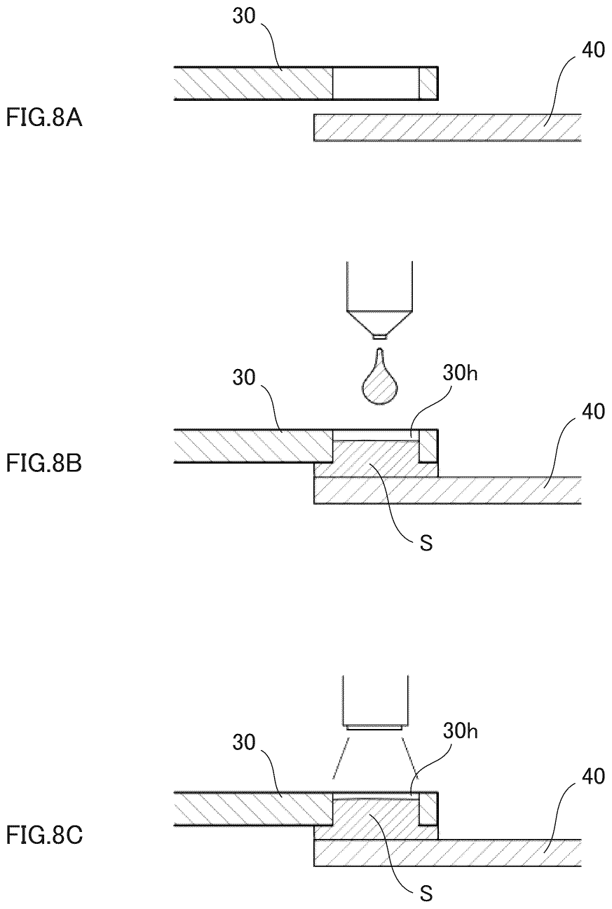

FIG. 6 is a view showing part of the assembly procedure of the measuring instrument and a jig used at the time of assembly. FIG. 7 is a flowchart showing the assembly procedure. FIGS. 8A to 8C are each a view schematically showing steps of applying an adhesive and curing the adhesive.

The jig 70 of FIG. 6 is configured to hold the scale member 40 at a predetermined fixed position. The jig 70 has a shape in which the main body 10 is positioned at a predetermined position relative to the jig 70.

In the assembly of the present embodiment, first, in step S1, an assembly (see FIG. 6) in which the probe 20, the movable member 30, and the like are attached to the main body 10 is prepared.

Next, in step S2, the scale member 40 is disposed at a predetermined position of the jig 70. Next, in step S3, the assembly prepared in step S1 is attached to the jig 70. In this state, as shown in FIG. 6, the through hole 30h of the movable member 30 is exposed upward through an opening 10h of the main body 10.

Next, in step S4, as shown in FIG. 8A, the adhesive S is applied from above to the movable member 30 and the scale member 40 in a state where the movable member 30 overlaps the scale member 40 (FIG. 8B). A dispenser is used to apply the adhesive S, for example.

Through the through hole 30h, the adhesive S enters the gap, where the movable member 30 and the scale member 40 face each other. Then, the adhesive S is cured. The curing of the adhesive S is performed, for example, by irradiating the adhesive S with light (FIG. 8C). The irradiation light may be, as an example, UV light (ultraviolet light).

In the configuration of the present embodiment, it is possible to radiate light onto the through hole 30h of the movable member 30, thereby allowing the curing time of the adhesive S to be shortened. That is, in a configuration in which no through hole 30h is formed, it is necessary to radiate light from an outer peripheral portion of the adhesive that is sandwiched between the movable member 30 and the scale member 40. In this case, a relatively long curing time is required. In contrast, the configuration of the present embodiment provides an effect of enabling the adhesive to be cured in a shorter time compared to such a configuration. In particular, in a case where the through hole 30h is formed relatively large, for example, when the area of the through hole 30h is 20% or more of the area of the bonding region, light more easily enters in the through hole 30h, thereby allowing the adhesive to be cured more effectively.

Next, in step S5, the detection member 50 is attached to the main body 10. The detection member 50 is attached by using a fixing tool such as a screw, for example. Through the series of above-described steps, the measuring instrument S100 is manufactured.

### (Through Hole and Peripheral Structure Thereof)

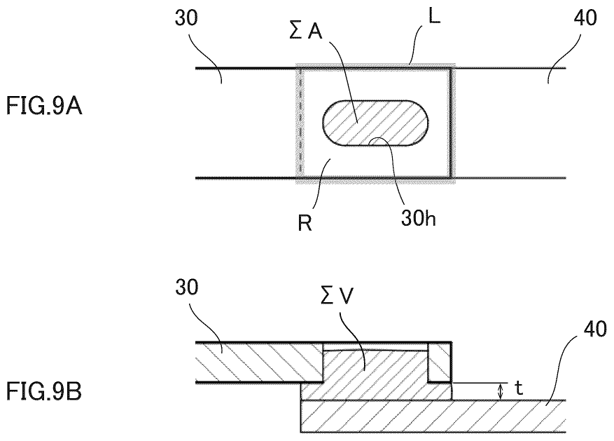

FIGS. 9A and 9B are each a diagram for explaining a specific configuration example of a through hole and its peripheral structure. Regarding the area of the through hole 30h, it is preferable in one embodiment that the area of the through hole 30h satisfies the following condition:

$$Σ A ≧ L \times t$$

Here, ΣA is the area of the through hole (the total area when a plurality of through holes are provided), L is the outer peripheral length of the bonding region R, and t is the thickness of the gap between the movable member 30 and the scale member 40.

The above defines the condition for allowing the adhesive S to escape into the through hole. By satisfying this condition, the likelihood that the adhesive S escapes from a bonding margin of the side surface rather than the through hole is reduced.

Regarding the volume of the through hole 30h, it is preferable in one embodiment that the volume of the through hole 30h satisfies the following condition:

$$Σ V ≧ {S}_{r} \times 2 \times σ$$

Here, ΣV is the volume of the through hole (the total volume a plurality of through holes are provided), Sᵣ is the area of the bonding region R, and σ is the variation of the thickness t.

By satisfying the above-described condition, it is possible to more effectively accommodate the variation in the thickness t of the gap between the movable member 30 and the scale member 40. In one embodiment of the measuring instrument S100, the thickness t is assumed to be approximately 0.2 mm to 0.3 mm, and the variation σ is assumed to be approximately 0.25 mm. When these values are applied to the above equation, ΣV≥Sᵣ×2×0.25=0.5×Sᵣ=Sᵣ/2. That is, in this example, ΣV≥Sᵣ/2.

### (Effects of the Measuring Instrument S100)

According to the measuring instrument S100 of the present embodiment as described above, since the movable member 30 is provided with the through hole 30h, even if the gap between the movable member 30 and the scale member 40 fluctuates, the adhesive S is prevented from protruding or from failing to sufficiently spread between the members. As a result, the scale member 40 can be accurately positioned relative to the detection member 50. Therefore, it is possible to prevent a decrease in the detection accuracy of the measuring instrument due to poor adhesion between the members.

### <Modification>

Although the embodiments of the present disclosure have been described above with reference to the drawings, the present disclosure is not limited to the above description and can be variously modified.

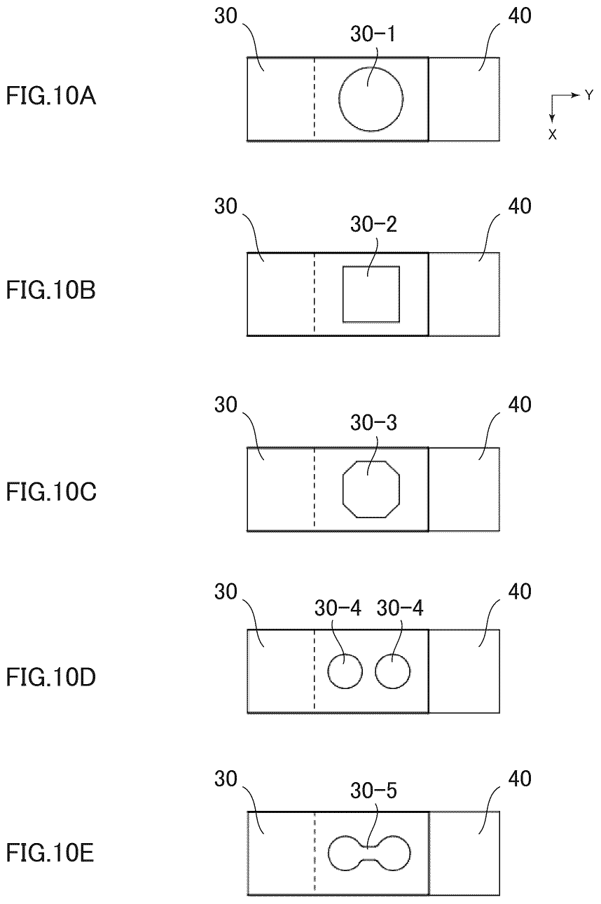

FIGS. 10A and 10B are each a view showing an example of the through hole. In FIG. 10A, a circular through hole 30-1 is formed in the movable member 30 at a connection portion between the movable member 30 and the scale member 40. A through hole 30-2 shown in FIG. 10B has a quadrangular shape. A through hole 30-3 shown in FIG. 10C has an octagonal shape in which four corners of a quadrangle are cut off. In a configuration shown in FIG. 10D, a plurality of through holes 30-4 are formed. A through hole 30-5 shown in FIG. 10E is a through hole formed in which a plurality of holes are connected to each other. In this manner, the shape and the number of the through holes can be appropriately changed.

In the above embodiment, the configuration in which the through hole 30h is formed in the movable member 30 is exemplified. However, one or a plurality of through holes may be formed in the scale member 40. Additionally, one or a plurality of through holes may be formed in both the movable member 30 and the scale member 40.

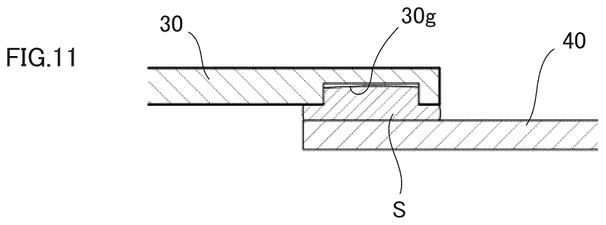

FIG. 11 is a cross-sectional view illustrating an example in which a recessed portion is formed in the movable member. In place of the through hole 30h of the above embodiment, one or a plurality of recessed portions 30g may be formed in the movable member 30. The recessed portion 30g is cut out in the thickness direction of the member from the surface facing the scale member 40. The recessed portion 30g does not penetrate through the movable member 30. It should be noted that such a recessed portion may be formed in the scale member 40.

In the above-described embodiment, the electromagnetic induction type measuring instrument S100 is exemplified, but a type of the measuring instrument may be any type, such as a capacitive type, optical type, and magnetic type. In addition, the configuration is not limited to a case where the scale member 40 is movable while the detection member 50 is fixed. Conversely, it may be a configuration in which the detection member 50 is movable while the scale member 40 is fixed. Furthermore, although the lever-type measuring instrument S100 is exemplified in the above embodiment, the connection structure according to the present disclosure can also be applied to measuring instruments other than the lever-type measuring instrument. For example, in a configuration in which a movable member and a scale member that are directly or indirectly fixed to a probe slide in the longitudinal direction of the main body, the above-described configuration may be used for a connection structure that connects the movable member and the scale member.

Additionally, the present disclosure is not necessarily used only for a measuring instrument having a detection member, and may be used for a predetermined device that does not have a detection member. The present application also discloses a connection structure, and the connection structure includes, as an example, a probe provided to be movable relative to a main body, a movable member provided so as to move with the probe, and a scale member fixed to a part of the movable member, wherein the movable member and the scale member are fixed to each other by having the movable member and the scale member bonded with an adhesive in a bonding region where the movable member and the scale member overlap each other, and in the bonding region, at least one of the movable member or the scale member includes one or a plurality of through holes or one or a plurality of recessed portions into which the adhesive enters.

In the configuration in which the recessed portion is provided instead of the through hole 30h, the above-described description regarding the length d2 of the bonding region R and the length d1 of the through hole 30h is directly applicable to the description of the recessed portion. The same applies to the relationship between the area of the recessed portion and the area of the bonding region. That is, in one embodiment of the present disclosure, the maximum length inside the recessed portion may be 20% or more of the length of the bonding region in the direction orthogonal to the extending direction of the scale member. The area of the recessed portion may be 20% or more of the area of the bonding region. Similarly to the through hole, the maximum length inside the recessed portion may be 30% or more of the length of the bonding region in the direction orthogonal to the extending direction of the scale member, and the area of the recessed portion may be 30% or more of the area of the bonding region. When a plurality of through holes or recessed portions are provided, the total area thereof may be 20% or more or 30% or more of the area of the bonding region.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

The present application discloses the subject matter according to the following appended notes.

(Appended note 1) A measuring instrument including: a main body; a probe movable relative to the main body; a movable member provided to move with the probe; a scale member fixed to a part of the movable member; and a detection member that electrically detects a displacement of the scale member, wherein the movable member and the scale member are fixed to each other by bonding with an adhesive in a bonding region where the movable member and the scale member overlap each other, and wherein in the bonding region, a measuring instrument in which at least one of the movable member and the scale member is formed with a through hole or a recessed portion, into which the adhesive enters.

(Appended note 2) The measuring instrument according to Appended note 1, wherein the maximum length inside the through hole or the recessed portion is 20% or more of a length of the bonding region in a direction orthogonal to an extending direction of the scale member.

(Appended note 3) The measuring instrument according to Appended note 1, wherein the area of the through hole or the area of the recessed portion is 20% or more of the area of the bonding region.

(Appended note 4) The measuring instrument according to any one of Appended notes 1 or 3, wherein, a thickness of the movable member or the scale member in which the through hole is formed is greater than a thickness of a gap filled with the adhesive.

(Appended note 5) The measuring instrument according to any one of Appended notes 1 to 4, wherein the adhesive is a photocurable adhesive that is cured by irradiation with light, and the through hole is formed in at least one of the movable member or the scale member.

(Appended note 6) A measuring instrument including: a main body; a probe movable relative to the main body; a movable member provided to move with the probe; a scale member fixed to a part of the movable member; and a detection member that electrically detects a displacement of the scale member, wherein the movable member and the scale member are fixed to each other by bonding with an adhesive in a bonding region where the movable member and the scale member overlap each other, and wherein in the bonding region, a measuring instrument in which at least one of the movable member and the scale member is formed with a plurality of through holes or a plurality of recessed portions, into which the adhesive enters.

(Appended note 7) The measuring instrument according to Appended note 6, wherein a total area of the plurality of through holes or a total area of the plurality of recessed portions is 20% or more of an area of the bonding region.

(Appended note 8) The measuring instrument according to Appended note 6 or 7, wherein, a thickness of the movable member or the scale member in which the through hole is formed is greater than a thickness of a gap filled with the adhesive.

(Appended note 9) The measuring instrument according to any one of Appended note 6 to 8, wherein adhesive is a photocurable adhesive that is cured by irradiation with light, and at least one of the movable member or the scale member includes the plurality of through holes.

(Appended note 10) A connection structure including: a movable member movably provided relative to a main body; and a scale member fixed to a part of the movable member, wherein the movable member and the scale member are fixed to each other by bonding with an adhesive in a bonding region where the movable member and the scale member overlap each other, and in the bonding region, at least one of the movable member or the scale member includes one or a plurality of through holes or one or more recessed portions, into which the adhesive enters.

(Appended note 11) The connection structure according to Appended note 10, wherein the adhesive is a photocurable adhesive that is cured by irradiation with light, and the one or a plurality of through holes are formed in one of the movable member and the scale member.

(Appended note 12) The connection structure according to Appended note 10 or 11, wherein a total area of the one or a plurality of through holes is 20% or more of the area of the bonding region.

What is claimed is:

1. A measuring instrument comprising:
a main body;
a probe movable relative to the main body;
a movable member provided to move with the probe;
a scale member fixed to a part of the movable member; and
a detection member that electrically detects a displacement of the scale member,
wherein the movable member and the scale member are fixed to each other by bonding with an adhesive in a bonding region where the movable member and the scale member overlap each other, and
wherein, in the bonding region, at least one of the movable member or the scale member includes a through hole or a recessed portion, into which the adhesive enters.

2. The measuring instrument according to claim 1, wherein a maximum length inside the through hole or the recessed portion is 20% or more of a length of the bonding region in a direction orthogonal to an extending direction of the scale member.

3. The measuring instrument according to claim 1, wherein an area of the through hole or an area of the recessed portion is 20% or more of an area of the bonding region.

4. The measuring instrument according to claim 1, wherein a thickness of the movable member or the scale member in which the through hole is formed is greater than a thickness of a gap filled with the adhesive.

5. The measuring instrument according to claim 1, wherein the adhesive is a photocurable adhesive that is cured by irradiation with light, and the through hole is formed in at least one of the movable member or the scale member.

6. A measuring instrument comprising:
a main body;
a probe movable relative to the main body;
a movable member provided to move with the probe;
a scale member fixed to a part of the movable member; and
a detection member that electrically detects a displacement of the scale member,
wherein the movable member and the scale member are fixed to each other by bonding with an adhesive in a bonding region where the movable member and the scale member overlap each other, and
wherein, in the bonding region, at least one of the movable member or the scale member includes a plurality of through holes or a plurality of recessed portions, into which the adhesive enters.

7. The measuring instrument according to claim 6, wherein a total area of the plurality of through holes or a total area of the plurality of recessed portions is 20% or more of an area of the bonding region.

8. The measuring instrument according to claim 6, wherein, a thickness of the movable member or the scale member in which the through hole is formed is greater than a thickness of a gap filled with the adhesive.

9. The measuring instrument according to claim 6, wherein adhesive is a photocurable adhesive that is cured by irradiation with light, and at least one of the movable member or the scale member includes the plurality of through holes.

10. A connection structure comprising:
a movable member movably provided relative to a main body; and
a scale member fixed to a part of the movable member, wherein the movable member and the scale member are fixed to each other by bonding with an adhesive in a bonding region where the movable member and the scale member overlap each other, wherein, in the bonding region, at least one of the movable member or the scale member includes one or a plurality of through holes or one or a plurality of recessed portions, into which the adhesive enters.

11. The connection structure according to claim 10, wherein the adhesive is a photocurable adhesive that is cured by irradiation with light, and the one or a plurality of through holes are formed in at least one of the movable member or the scale member.

12. The connection structure according to claim 10, wherein a total area of the one or a plurality of through holes is 20% or more of an area of the bonding region.
